(19) United States
(12) Patent Application Publication
(10) Pub. No.: US 2024/0289909 A1
(43) Pub. Date: Aug. 29, 2024

(54) SYSTEM AND METHOD TO ENHANCE WORKER SAFETY

(71) Applicant: Mirza Muhammad Ajmal Beg, Calgary (CA)

(72) Inventor: Mirza Muhammad Ajmal Beg, Calgary (CA)

(21) Appl. No.: 18/586,327

(22) Filed: Feb. 23, 2024

Related U.S. Application Data
(60) Provisional application No. 63/486,995, filed on Feb. 26, 2023.

(51) Int. Cl. G06Q 50/26; G05D 1/246; G05D 1/247; G05D 1/617

(52) U.S. Cl. CPC G06Q 50/265; G05D 1/246; G05D 1/247; G05D 1/617

(57) ABSTRACT

A computer-implemented method and system to enhance safety of one or more workers comprising worker safety management systems, mobile worker safety base stations, robots and one or more wearable devices. The computer-implemented method comprising the steps of: (a) detecting one or more safety issues by the one or more mobile worker safety base stations by using one or more data received from the one or more wearable devices; (b) communicating to the robots by the mobile worker safety base stations, to change their positions with or without using one or more downloaded maps to locate positions where wireless communication links are available and, transmitting signals and/or data based on the received data related to the detected safety issues from the mobile worker safety base stations.

### CROSS REFERENCE TO RELATED APPLICATIONS

This application claims priority of U.S. Provisional Application No. 63/486,995 (SYSTEM AND METHOD TO ENHANCE WORKER SAFETY) filed Feb. 26, 2023 which is further based on U.S. 63/314,427 (SYSTEM AND METHOD TO ENHANCE WORKER SAFETY) filed on Feb. 27, 2022 filed on Feb. 27, 2022. U.S. Provisional Application No. 63/486,995 is incorporated herein by reference.

### BACKGROUND

### Field of the Invention

The present invention is directed to a system, computer-implemented method and computer readable medium with computer instructions to enhance safety of one or more workers at one or more worksites without (reliable) GPS signals and/or without one or more (reliable) wireless communication links. This provisional application is an improvement for Provisional application.

### Description of the Related Art

A wearable device communicates one or more safety issues faced by a worker by using one or more wireless communication links. The one or more positions of the worker facing one or more safety issues is determined using GPS signals and is transferred through one or more wireless communication links by the wearable device. Such wearable devices are designed for limited aspects of overall worker safety and are ineffective in ensuring help when the worker is facing one or more safety issues and, GPS signals and/or one or more wireless communication links are not available and/or not reliable for one or more effective wireless communications. There is need for a computer-implemented method and system which can enhance one or more workers safety at one or more worksites where GPS signals and/or one or more wireless communication links are not available and/or not reliable enough for the one or more effective wireless communications.

### SUMMARY

In one exemplary embodiment of the present invention, one or more worker safety management systems, one or more mobile worker safety base stations, one or more robots and one or more wearable devices collaborate to enable reliable wireless communication related to one or more safety issues occurred at worksites without GPS signals and/or one or more reliable wireless communication links. In another exemplary embodiment of the present invention, one or more mobile worker safety base stations provide safety monitoring which is not feasible by one or more wearable devices worn by the one or more workers. In another exemplary embodiment of the present invention, one or more mobile worker safety base stations are assigned based on the power required to continue monitoring throughout the one or more required time lengths of safety monitoring. In another exemplary embodiment of the present invention, one or more mobile worker safety base stations continue safety monitoring when one or more wearable devices become faulty and/or power required to continue monitoring by the one or more wearable devices no longer available. In another exemplary embodiment of the present invention, one or more mobile worker safety base stations perform safety monitoring when different types of wearable devices are being used. In another exemplary embodiment of the present invention, one or more mobile worker safety base stations are assigned based on the power required to continue monitoring throughout the one or more required time lengths of safety monitoring. In another exemplary embodiment of the present invention, one or more mobile worker safety base stations are assigned based on the power required to continue monitoring throughout the one or more required time lengths of safety monitoring. In another exemplary embodiment of the present invention, one or more worker safety management systems enable use of wearable devices of multiple specifications at the same workplace. In another exemplary embodiment of the present invention, one or more worker safety management systems enable correct assigning of one or more mobile worker safety base stations according to the safety requirements.

### BRIEF DESCRIPTION OF THE DRAWINGS

FIG. 1 shows a block diagram of an example computer used to provide computing functionalities to implement the present invention.

FIG. 2 illustrates exemplary overall architecture according to the present invention.

FIG. 3 illustrates an exemplary data model used by exemplary Worker Safety Management System according to the present invention.

FIG. 4 is a diagram conceptually illustrating an exemplary Worker Safety Management System according to the present invention.

FIG. 5 illustrates an exemplary data model used by an exemplary Mobile Worker Safety Base Station according to the present invention.

FIG. 6 is a diagram conceptually illustrating an exemplary Mobile Worker Safety Base Station according to the present invention.

FIG. 7 is a flow chart illustrating an exemplary operation by the exemplary one or more Worker Safety Management Systems according to the present invention.

FIG. 8 is a flow chart illustrating an exemplary operation according to the present invention by the exemplary one or more Mobile Worker Safety Base Station according to the present invention.

FIG. 9 is a flow chart illustrating an exemplary operation of one or more robots and one or more Mobile Worker Safety Base Stations according to the present invention.

### DETAILED DESCRIPTION

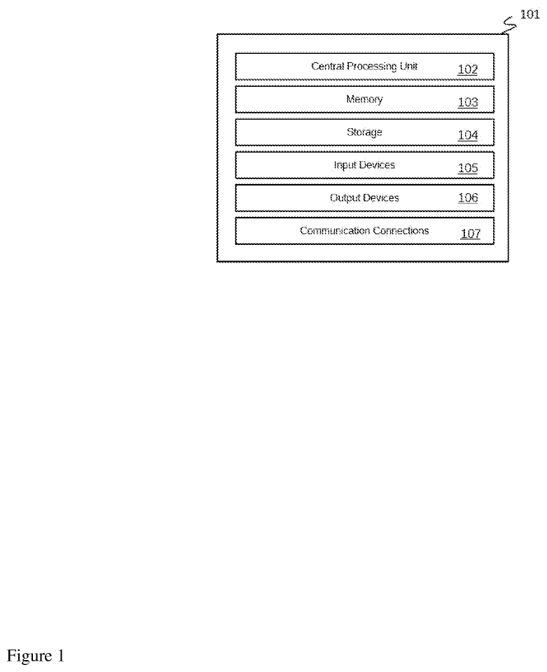

FIG. 1 shows a block diagram of an example computer 101 used to provide computing functionalities to implement the present invention. Computing devices such as laptop, workstation, laptops, distributed computing systems, desktop, server, cluster, virtual machine, mainframe, smart phone, wireless data port, a personal digital assistance, tablet computing devices are examples of such computer 101. The computer 101 includes a Processor 102 (e.g., a central processing unit (CPU), microprocessor, a digital signal processor (DSP), a conventional processor, a virtual process, micro-controller, virtual machine, a graphic processing unit (GPU), a radio-frequency integrated circuit (RFIC), an application specific integrated circuit (ASIC) or any suitable combination thereof). Processor 102 can be a multi-core processor or a plurality of multi-core processors. Memory 103 can be any kind of memory device such as read only memory (ROM), random access memory (RAM), optical, magnetic and flash memory. In some implementation, Memory 103 can be combination of two or more different types of memory. Memory 103 is shown as integral part of the computer 101, in alternative implementation memory 103 can be external to computer 101. Storage device 104 can be any medium which can be used as persistence storage. For example, hard drive, tape drive, optical disk drive, USB, flash driver and disk arrays. The storage device 104 is not limited to a particular storage device and may include memory devices such as ROM, RAM, hard disk, and the like. The storage device 104 may be a cloud storage device. Input device 105 is used to input external data and can be any kind of device such as mouse, trackball, light pen, bio-metric mechanism including voice recognition. Output device 106 can be any kind of device used for data output. For example, cathode-ray-tube (CRT) monitor, plasma display, crystal display, projector, printer and speaker. Communication interface 107 can be one or more interfaces to any kinds of networks such as internet, intranet, local area network, wide area network, a telephone network such as Public Switched Telephone Network, or combination of different kinds of networks. In some exemplary embodiments, the storage device 104 may connect to the example computer 101 using communication interface 107. The example computer system 101 can be a virtual machine or a cloud based computing device.

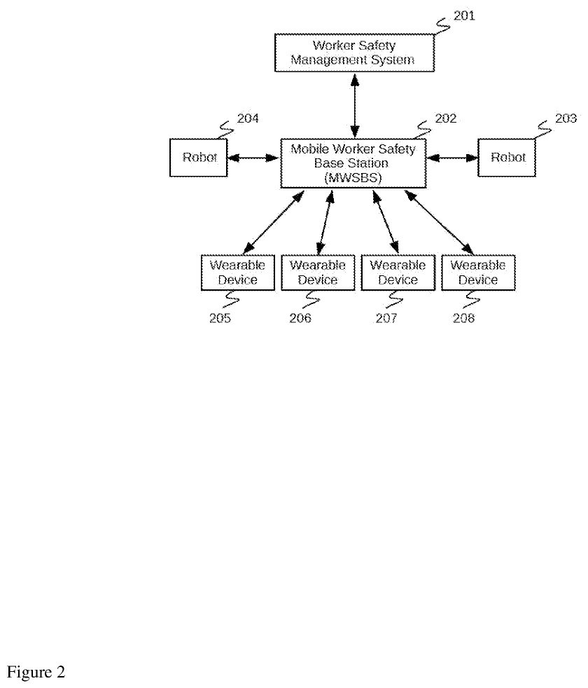

FIG. 2 illustrates exemplary overall architecture of the present invention. Worker Safety Management System 201 manages data required to ensure safety of one or more workers. FIG. 2 illustrates one Worker Safety Management System 201 for simplification purpose. In other exemplary embodiments, there may exist more then one Worker Safety Management Systems 201 collaborating with one another. The both expressions “Worker Safety Management System” and “Worker Safety Management Systems” may indicate one or more Worker Safety Management Systems 202 in this specification. Further, the both expressions “worker” and “workers” may indicate one or more human beings in this specification. The expressions “worker” and “workers” may also indicate one or more human beings accompanied by one or more animals (such as a trained dog or a horse carrying a person who is manage a flock of sheeps) where the one or more human beings and one or more accompanied animals are all considered worker.

The communication with one or more workers in this specification refers to communication with the one or more human beings only. The expression “or” is not exclusive throughout the specification. Worker Safety Management System 201 is connected to Mobile Worker Safety Base Station (MWSBS) 202. FIG. 2 illustrates one Mobile Worker Safety Base Station 202 for simplification purpose. In other exemplary embodiments, there may exist more then one Mobile Worker Safety Base Stations 202. The both expressions “Mobile Worker Safety Base Station” and “Mobile Worker Safety Base Stations” may indicate one or more Mobile Worker Safety Base Stations 202 in this specification. Mobile Worker Safety Base Station 202 is a mobile unit which can be moved to one or more worksites to help ensure safety of the one or more workers conducting one or more planned activities at one or more worksites. The both expressions “worksite” and “worksites” may indicate one or more worksites in this specification. A worksite can be also an agriculture worksite such as corn farm or a cow form. A worksite can be also an industrial worksite as a car assembly worksite or a mining site. Mobile Worker Safety Base Station 202 can communicate with one or more types of wearable devices 205 206 207 208 attached to one or more workers working on one or more worksites. Mobile Worker Safety Base Station 202 is equipped with GPS functionality and is able to determine and transmit current position. Mobile Worker Safety Base Station 202 also implements one or more of the following functionalities using at least one or more processors associated with one or memories and one or more sensors:
Ability to determine one or more concentrations of one or more gases in one or more ranges, in one or more surrounding environments.
Ability to detect one or more lights in one or more specific wavelength ranges such as ability to detect light with specific wavelength which can damage human eye and/or animal eye.
Ability to determine one or more intensity of one or more sounds in one or more specific ranges and over one or more specific time lengths such as ability to detect loud sound which can damage human ear and/or animal ear.
Ability to detect one or more vibrations in one or more specific intensity ranges such as detecting vibrations on the floor due to a mechanical disorder in a running machinery on the floor.
Ability to determine one or more concentration of one or more solid particles in one or more surrounding environments such as detecting detecting concentration of lung damaging particles in one or more surrounding environments.
Ability to determine strength of one or more magnetic fields in one or more surrounding environments such as detecting strong magnetic field in one or more surrounding environments that can interfere with one or more operations of one or more medical devices attached or embedded in human body and/or animal body.
Ability to determine one or more falls by determining the device tilt angle within one or more specific ranges for one or more time periods within one or more specific ranges.
Ability to determine one or more heat intensities in one or more surrounding environments.
Ability to determine one or more unconscious states by determining the device not changing tilt angle within one or more specific ranges for one or more time periods within one or more specific ranges.
Ability to analyze human sounds and/or animal sounds based on predefined configuration to determine need for help.

FIG. 2 illustrates four wearable devices 205 206 207 208 for simplification purpose. In other exemplary embodiments, one or more wearable devices may exist. The both expressions “wearable device” and “wearable devices” may indicate one or more wearable devices 205 206 207 208 in this specification.

The wearable device is attached directly or indirectly to body of the worker and help ensure the safety of the worker while the worker is physically present at one or more worksites. The wearable device according to this specification, implements one or more of the following functionalities using at least one or more processors associated with one or memories and one or more sensors:
Ability to determine one or more concentrations of one or more gases in one or more ranges, in one or more surrounding environments.
Ability to detect one or more lights in one or more specific wavelength ranges such as ability to detect light with specific wavelength which can damage human eye.
Ability to determine one or more intensity of sounds in one or more specific ranges and over one or more specific time lengths such as ability to detect loud sound which can damage human ear and/or animal ear.
Ability to detect one or more vibrations in one or more specific intensity ranges such as detecting vibrations on the floor due to a mechanical disorder in a running machinery on the floor.
Ability to determine one or more concentrations of one or more solid particles in one or more surrounding environments such as detecting detecting concentration of lung damaging particles in one or more surrounding environments.
Ability to determine one or more strengths of magnetic fields in one or more surrounding environments such as detecting one or more strong magnetic fields in one or more surrounding environments that can interfere with operation of medical devices attached or embedded in human body and/or animal body.
Ability to determine one or more falls by determining the one or more device angles within specific range for one or more time periods within one or more specific ranges.
Ability to determine one or more heat intensities in one or more surrounding environments.
Ability to determine one or more unconscious states by determining the device not changing tilt angle within one or more specific ranges for one or more time periods within one or more specific ranges.
Ability to analyze human sounds and/or animal sounds based on predefined configuration to determine need for help.
   The wearable device is able to generate one or more warnings. The wearable device may include means for wireless communication and/or GPS devices to communicate one or more safety issues through one or more wireless communication links including Wi-Fi, Bluetooth and satellite communication.

Mobile Worker Safety Base Station 202 can also communicate with one or more types of robots 203 204 which may be physically attached with Mobile Worker Safety Base Station 202 with releasable one or more attachments. FIG. 2 illustrates two robots 203 204 for simplification purpose. In other exemplary embodiment, any number of robots may communicate with one or more Mobile Worker Safety Base Stations 202. The both expressions “robot” and “robots” may refer to one or more robots in this specification. One or more Robots 203 204 can be ground mobile unit and/or flying vehicle such as mini drones. The one or more robots 203 204 moves from/to non-GPS signal worksite for the purpose of establishing one or more reliable wireless communication links. The Non-GPS Signal Worksite is a worksite where GPS signals do not exit or are reliable enough to be detected and used to determine position. The GPS signal worksite is a worksite where GPS signals exits and strong enough to be detected and can be used to determine position. The both expressions “worksite” and “worksites” refer to one or more worksites. The worksite may be defined by three-dimension space such as a work room on a second floor. Robots 203 204 also moves in one or more worksites with wireless communication signals and one or more worksites without wireless communication signals.

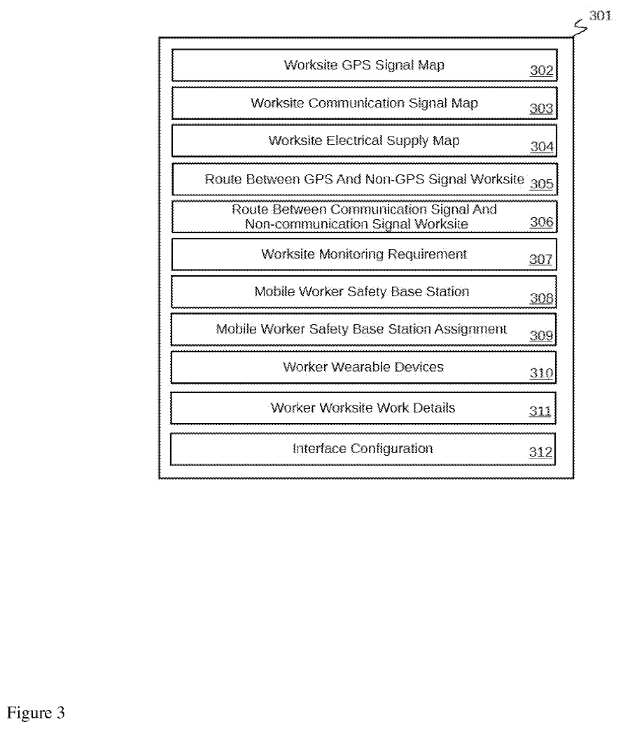

FIG. 3 illustrates an exemplary data model 301 used by exemplary Worker Safety Management System 201 401. It is a well known art that the data models can be merged, split and given a different name to what is presented here. Such variations are within the scope of the invention.

The data model Worksite GPS Signal Map 302 stores data related to one or more worksite maps identifying one or more GPS signal worksite and/or one or more Non-GPS signal worksites. The both expressions “map” and “maps” may indicate one or more maps in this specification. The data model worksite GPS Signal Map 302 also includes one or more data schema, filters, constraints, default values, validations, types, formats information, presentation templates and other configurations data which is used to create, read, delete and update the stored data. The data model Worksite GPS Signal Map 302 may also store one or more rules which may be based on one or more self-learning algorithms.

The data model Worksite Communication Signal Map 303 stores data related to one or more worksite maps identifying worksites with and without wireless communication signals. The data model worksite Communication Signal Map 303 also includes one or more data schema, filters, constraints, default values, validations, types, formats information, presentation templates and other configurations data which is used to create, read, delete and update the stored data. The data model Worksite Communication Signal Map 303 may also store one or more rules which may be based on one or more self-learning algorithms.

The data model Worksite Electrical Supply Map 304 stores data related to one or more worksite maps identifying one or more worksites with one or more functional electric power sockets. The data model worksite Electrical Supply Map 304 also includes one or more data schema, filters, constraints, default values, validations, types, formats information, presentation templates and other configurations data which is used to create, read, delete and update the stored data. The data model Worksite Electrical Supply Map 304 may also store one or more rules which may be based on one or more self-learning algorithms.

The data model Route Between GPS And Non-GPS Signal Worksite 305 stores data related to one or more routes between worksite with GPS signals and worksite without GPS signals for one or more robots. The both expressions “route” and “routes” may indicate one or more routes. The data model Route Between GPS And Non-GPS Signal Worksite 305 also includes one or more data schema, filters, constraints, default values, validations, types, formats information, presentation templates and other configurations data which is used to create, read, delete and update the stored data. The data model Route Between GPS And Non-GPS Signal Worksite 305 may also store one or more rules which may be based on one or more self-learning algorithms.

The data model Route Between Communication Signal And Non-communication Signal Worksite 306 stores data related to one or more routes between one or more Communication Signal worksites and one or more Non-communication Signal worksites. A Communication Signal worksite is a worksite where wireless communication signals exists and/or are reliable enough for effective one or more wireless communications. A non-communication Signal worksite is a worksite where wireless communication signals does not exist and/or are not reliable enough for one or more effective wireless communications. The data model Route between Communication Signal and Non-communication Signal worksite 306 also includes one or more data schema, filters, constraints, default values, validations, types, formats information, presentation templates and other configurations data which is used to create, read, delete and update the stored data. The Route Between Communication Signal And Non-communication Signal Worksite 306 may also store one or more rules which may be based on one or more self-learning algorithms.

The data model Worksite Monitoring Requirement 307 stores data related to one or more monitoring requirements based on one or more potential safety issues associated with one or more worksites to ensure safety of one or more workers. Different worksites may have different one or more monitoring requirements. For example: worksite A needs monitoring for gas A1 concentration above a certain level of A2 for specific time length A3 with a specific of type of wearable device A4, and the other worksite B needs monitoring for gas B1 concentration above a certain level B2 for specific time length B3 using a specific type of wearable device B4. The data model worksite Monitoring Requirement 307 also includes one or more data schema, filters, constraints, default values, validations, types, formats information, presentation templates and other configurations data which is used to create, read, delete and update the stored data. The Worksite Monitoring Requirement 307 may also store one or more rules which may be based on one or more self-learning algorithms.

The data model Mobile Worker Safety Base Station 308 stores data related to one or more Mobile Worker Safety Base Stations 202 that Worker Safety Management System 301 can utilize to ensure safety of the one or more workers at the one or more worksites. The data model Mobile Worker Safety Base Station 308 also includes one or more data schema, filters, constraints, default values, validations, types, formats information, presentation templates and other configurations data which is used to create, read, delete and update the stored data. The data model Mobile Worker Safety Base Station 308 may also store one or more rules which may be based on one or more self-learning algorithms and/or one or more specifications of the one or more Mobile Worker Safety Base Stations 202.

The data model Mobile Worker Safety Base Station Assignment 309 stores data related to one or more assignments of Mobile Worker Safety Base Station to specific worksites according to one or more predetermined work schedules for the one or more planned activities. The data model Mobile Worker Safety Base Station Assignment 309 also includes one or more data schema, filters, constraints, default values, validations, types, formats information, presentation templates and other configurations data which is used to create, read, delete and update the stored data. The data model Mobile Worker Safety Base Station Assignment 309 may also store one or more rules which may be based on one or more self-learning algorithms.

The data model Worker Wearable Devices 310 stores data related to wearable devices that monitors the safety of the one or more workers at one or more worksites based on the one or more potential safety issues associated the one or more planned activities and, generate and send one or more notifications when the safety of the one or more workers is endangered or expected to be endangered. The data model Worker Wearable Devices 310 also includes one or more data schema, filters, constraints, default values, validations, types, formats information, presentation templates and other configurations data which is used to create, read, delete and update the stored data. The data model Worker Wearable Devices 310 may also store one or more rules which may be based on one or more self-learning algorithms.

The data model Worker Worksite Work Details 311 stores data related to one or more workers' one or more planned activities and associated one or more potential safety issues at the one or more worksites. The data model Workers Worksite Work Details 311 also includes one or more data schema, filters, constraints, default values, validations, types, formats information, presentation templates and other configurations data which is used to create, read, delete and update the stored data. The data model Worker Worksite Work Details 311 may also store one or more rules which may be based on one or more self-learning algorithms.

The data model Interface Configuration 312 stores data related to interfacing of Worker Safety Management System 301 with one or more external interfaces and/or one or more internal interfaces. The data model Interface Configuration 312 also includes one or more data schema, filters, constraints, default values, validations, types, formats information, presentation templates and other configurations data which is used to create, read, delete and update the stored data. The data model Interface Configuration 312 may also store one or more rules which may be based on one or more self-learning algorithms.

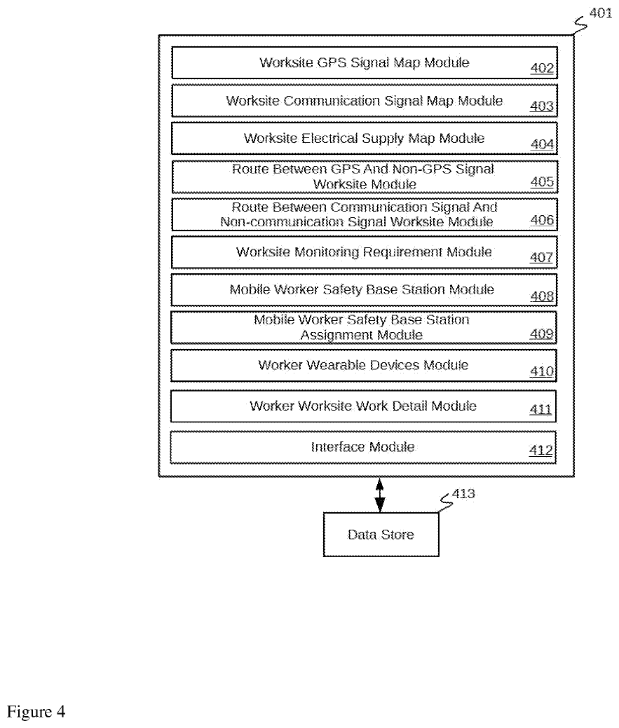

FIG. 4 is a diagram conceptually illustrating an exemplary Worker Safety Management System 401 201 according to the present invention. The exemplary system 401 stores information in data store 413. The data store 413 can be one or more distributed data stores. The data store 431 can be a partially or fully one or more cloud based. The exemplary system 401 generally consists of multiple modules 402-412. It is a known art to a person skilled in the art that the modules can be split, merged and renamed. All such variations are within scope of the invention. It is a known art to a person skilled in the art that a ‘module’ can be replaced with other means of grouping relevant computer instructions such as in form of functions, subroutines, routines, components, services and micro-services. All such variations known to a person skilled in the art are within the scope of the present invention. It is also a known art that modules can be distributed to multiple computing environments. Such variations known to a person skilled in the art are within the scope of the present inventions.

The module Worksite GPS Signal Map Module 402 contains computer instructions to create, read, update and delete data related to GPS signals reception at one or more worksites by using Worksite GPS Signal Map 302. The module Worksite GPS Signal Map Module 402 may further perform act of, by optionally using one or more stored rules in Worksite GPS Signal Map 302:
Maintaining Worksite GPS Signal Map 302 according to one or more predefined schedules and/or in response to one or more predefined events.

The module Worksite Communication Signal Map Module 403 contains computer instructions to create, read, update and delete data related to wireless communication signal reception at one or more worksites by using Worksite Communication Signal Map 303. The module Worksite Communication Signal Map Module 403 may further perform act of, by optionally using one or more stored rules in Worksite Communication Signal Map 303:
Maintaining Worksite Communication Signal Map 303 according to one or more predefined schedules and/or in response to one or more predefined events.

The module Worksite Electrical Supply Map Module 404 contains computer instructions to create, read, update and delete data related to worksite of functional electric power sockets at one or more worksites by using Worksite Electrical Supply Map 304. The module Worksite Electrical Supply Map Module 404 may further perform act of, by optionally using one or more stored rules in Worksite Electrical Supply Map 304:
Maintaining Worksite Electrical Supply Map 304 according to predefined one or more schedules and/or in response to one or more predefined events.

The module Route Between GPS And Non-GPS Signal Worksite Module 405 contains computer instructions to create, read, update and delete data related to one or more routes between one or more GPS signal worksites and one or more non-GPS signal worksites for one or more robots by using Route Between GPS And Non-GPS Signal Worksite 305. The module Route Between GPS And Non-GPS Signal Worksite Module 405 may further perform act of, by optionally using one or more stored rules in Route Between GPS And Non-GPS Signal Worksite 305:
Maintaining Route Between GPS And Non-GPS Signal Worksite 305 based one or more predefined schedules and/or in response to one or more predefined events.

The module Route between Communication Signal and Non-communication Signal Worksite Module 406 contains computer instructions to create, read, update and delete data related to one or more routes between one or more worksites with (reliable) wireless communication signals and one or more worksites without (reliable) wireless communication signals by using Route Between Communication Signal And Non-communication Signal Worksite 306. The module Route Between Communication Signal And Non-communication Signal Worksite Module 406 may further perform act of, by optionally using one or more stored rules in Route Between Communication Signal And Non-communication Signal Worksite 306:
Maintaining Route Between Communication Signal And Non-communication Signal Worksite 306 according to one or more predefined schedules and/or in response to one or more predefined events.

The module Worksite Monitoring Requirement Module 407 contains computer instructions to create, read, update and delete data related to one or more monitoring requirements based on one or more potential safety issues associated with one or more worksites to ensure safety of one or more workers by using Worksite Monitoring Requirement 307. The module Worksite Monitoring Requirement Module 407 may further perform act of, by optionally using one or more stored rules in Worksite Monitoring Requirement 307:
Maintaining Worksite Monitoring Requirement 307 according to one or more predetermined schedules and/or in response to one or more predefined events.

The module Mobile Worker Safety Base Station Module 408 contains computer instructions to create, read, update and delete data related to Mobile Worker Safety Base Stations 202 by using Mobile Worker Safety Base Station 308. The module Mobile Worker Safety Base Station Module 408 may further perform act of, by optionally using one or more stored rules in Mobile Worker Safety Base Station 308:
Maintaining Mobile Worker Safety Base Station 308 according to one or more predetermined schedules and/or in response to one or more predefined events.

The module Mobile Worker Safety Base Station Assignment Module 409 contains computer instructions to create, read, update and delete data related to one or more assignments of Mobile Worker Safety Base Stations 202 to one or more worksites according to one or more predetermined work schedules for the one or more planned activities to ensure safety of the one or more workers by using Mobile Worker Safety Base Station Assignment 309. The module Mobile Worker Safety Base Station Assignment Module 409 may further perform act of, by optionally using one or more stored rules in Mobile Worker Safety Base Station Assignment 309:
Maintaining Mobile Worker Safety Base Station Assignment 309 according to one or more predetermined schedules and/or in response to one or more predefined events.

The module Worker Wearable Devices Module 410 contains computer instructions to create, read, update and delete data related to one or more workers' wearable devices by using Worker Wearable Devices 310. The module Worker Wearable Devices Module 410 may further perform act of, by optionally using one or more stored rules in Worker Wearable Devices 310:
Maintaining Worker Wearable Devices 310 according to one or more predetermined schedules and/or in response to one or more predefined events.

The module Worker Worksite Work Detail Module 411 contains computer instructions to create, read, update and delete data related to one or more workers' one or more planned activities at one or more worksites by using Worker Worksite Work Detail 311. The module Worker Worksite Work Detail Module 411 may further perform act of, by optionally using one or more stored rules in Worker Worksite Work Detail 311:
Maintaining Worker Worksite Work Detail 311 according to one or more predetermined schedules and/or in response to one or more predefined events.

The module Interface Module 412 contains computer instructions to create, read, update and delete data related to implementation of external and/or internal interface management by using Interface Configuration 312. The data received by the Interface Module 412 through one or more APIs may go through one or more extract transfer load (ETL) and/or extract load transfer (ELT) processes.

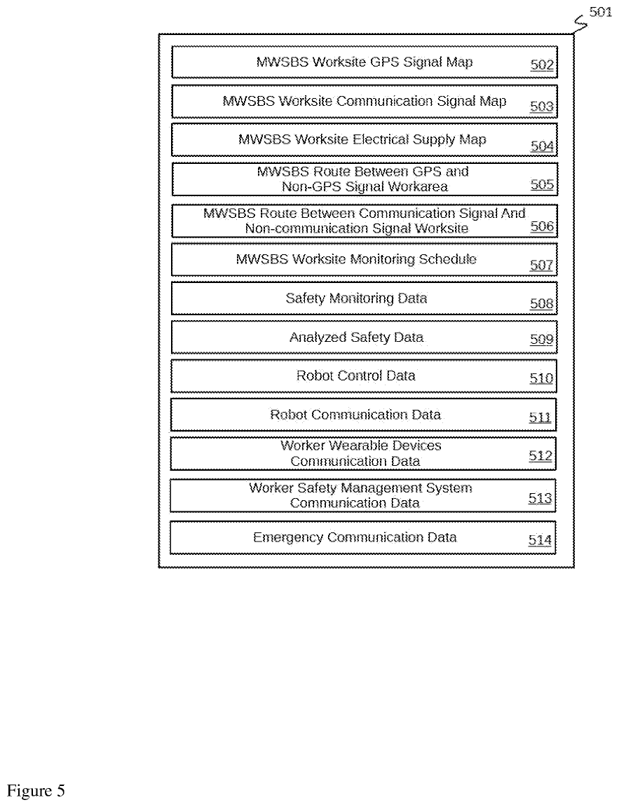

FIG. 5 illustrates an exemplary data model 501 used by Mobile Worker Safety Base Station 202 601. It is a well known art that the data models can be merged, split and given a different name to what is presented here. Such variation are within the scope of the invention.

The data model MWSBS Worksite GPS Signal Map 502 stores data related to one or more worksite maps identifying GPS Signal Worksites And Non-GPS Signal worksites within the one or more worksites. The data model MWSBS Worksite GPS Signal Map 502 may store one or more rules and/or one or more predefined events.

The data model MWSBS Worksite Communication Signal Map 503 stores data related to one or more worksites maps identifying one or more worksites with and without (reliable) wireless communication signals. The data model MWSBS Worksite Communication Signal Map 503 may store one or more rules and/or one or more predefined events.

The data model MWSBS Worksite Electrical Supply Map 504 stores data related to one or more worksite maps identifying worksites with functional electric power sockets. The data model MWSBS Worksite Electrical Supply Map 504 may store one or more rules and/or one or more predefined events.

The data model MWSBS Route Between GPS And Non-GPS Signal Worksite 505 stores data related to one or more routes between worksite with GPS signals and Worksite without GPS signal for one or more robots. The data model MWSBS Route Between GPS And Non-GPS Signal Worksite 505 may store one or more rules and/or one or more predefined events.

The data model MWSBS Route Between Communication Signal And Non-communication Signal Worksite 506 stores data related to one or more routes between one or more communication signal worksites and one or more non-communication signal worksites for one or more robots. The data model MWSBS Route Between Communication Signal And Non-communication Signal Worksite 506 may store one or more rules and/or one or more predefined events.

The data model MWSBS Worksite Monitoring Schedule 507 stores data related to one or monitoring schedules for one or more worksites to ensure safety of one or more workers. The data model MWSBS Worksite Monitoring Schedule 507 may store one or more rules and/or one or more predefined events.

The data model Safety Monitoring Data 508 stores data related to monitoring for the purpose of ensuring safety of one or more workers at the one or more worksites. The Safety Monitoring Data 508 may also include monitoring data generated by MWSBS when the wearable devices used at the one or more worksites do not satisfy one or more monitoring requirements.

The data model Analyzed Safety Data 509 stores data related to insights and analysis results for the data stored in the data model Safety Monitoring Data 508. The data model Analyzed Safety Data 509 may also store one or more rules to manage one or more life cycles of the stored one or more insights and one or more analysis results.

The data model Robot Control Data 510 stores data related to one or more controls and/or and one or more configurations of one or more robots that change one or more positions and communicate through one or more wireless communication links with MWSBS 202. The data model Robot Control Data 510 may also store one or more rules to manage one or more life cycles of the stored control data.

The data model Robot Communication Data 511 stores data related to communication with one or more robots. The data model Robot Communication Data 511 may also store one or more rules to manage one or more life cycles of the stored communication data.

The data model Worker Wearable Devices Communication Data 512 stores data related to communication with one or more wearable devices worn by the one or more workers at the one or more worksites. The data model Worker Wearable Devices Communication Data 512 may also store one or more rules to manage one or more life cycles of the stored communication data.

The data model Worker Safety Management System Communication Data 513 stores data related to communication with Worker Safety Management System 201. The data model Worker Safety Management System Communication Data 513 may also store one or more rules to manage one or more life cycles of the stored communication data.

The data model Emergency Communication Data 514 stores data related to communication with one or more external emergency services and/or one or more internal emergency services and/or one or more help dispatch units services. The data model Emergency Communication Data 514 may also store one or more rules to manage one or more life cycles of the stored communication data.

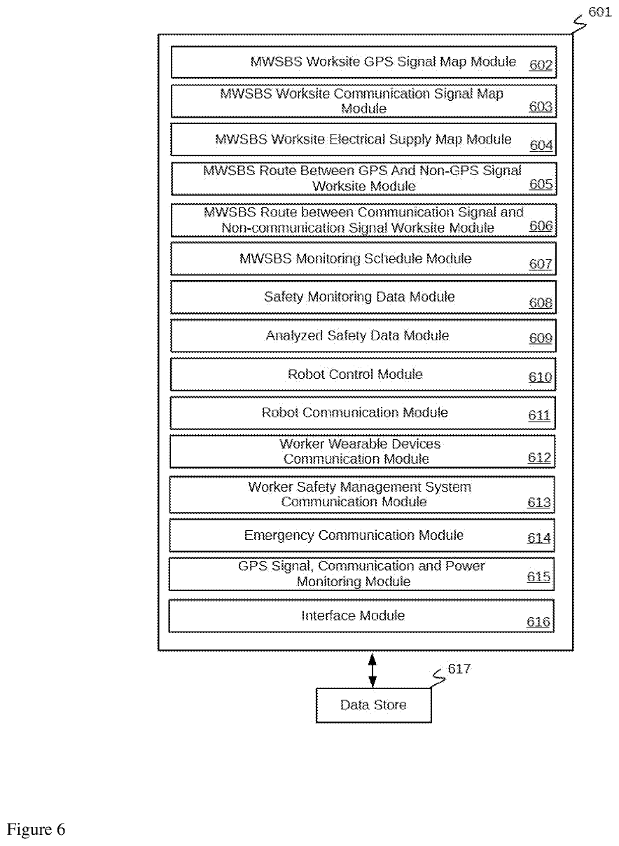

FIG. 6 is a diagram conceptually illustrating an exemplary Mobile Worker Safety Base Station 202 601 according to the present invention.

The module MWSBS Worksite GPS Signal Map Module 602 contains computer instructions to create, read, update and delete data related to one or more GPS worksite maps and/or one or more non-GPS maps by using MWSBS Worksite GPS Signal Map 502. The module MWSBS Worksite GPS Signal Map Module 602 enables transfer of data to MWSBS Worksite GPS Signal Map 502 from Worker Safety Management System 201 based on one or more stored rules and/or one or more stored predefined one or more events in MWSBS Worksite GPS Signal Map 502.

The module MWSBS Worksite Communication Signal Map Module 603 contains computer instructions to create, read, update and delete data related to the one or more Communication Signal worksites and/or one or more non-Communication Signal worksites by using MWSBS Worksite Communication Signal Map 503. The module MWSBS Worksite Communication Signal Map Module 603 enables transfer of data to MWSBS Worksite Communication Signal Map 503 from Worker Safety Management System 201 based on one or more stored rules and/or one or more stored predefined one or more events in MWSBS Worksite Communication Signal Map 503.

The module MWSBS Worksite Electrical Supply Map Module 604 contains computer instructions to create, read, update and delete data related to one or more worksite maps identifying worksites with functional electric power sockets, by using MWSBS Worksite Electrical Supply Map 504. The module MWSBS Worksite Electrical Supply Map Module 604 enables transfer of data to MWSBS Worksite Electrical Supply Map 504 from Worker Safety Management System 201 based on one or more stored rules and/or one or more stored predefined one or more events in MWSBS Worksite Electrical Supply Map 504.

The module MWSBS Route Between GPS And Non-GPS Signal Worksite Module 605 contains computer instructions to create, read, update and delete data related to one or more routes between worksite with GPS signals and worksite without GPS signals for one or more robots, by using MWSBS Route Between GPS And Non-GPS Signal Worksite 505. The module MWSBS Route Between GPS And Non-GPS Signal Worksite Module 605 enables transfer of data to MWSBS Route Between GPS And Non-GPS Signal Worksite 505 from Worker Safety Management System 201 based on one or more stored rules and/or one or more stored predefined one or more events in MWSBS Route Between GPS And Non-GPS Signal Worksite 505.

The module MWSBS Route Between Communication Signal and Non-communication Signal Worksite Module 606 contains computer instructions to create, read, update and delete data related to by using MWSBS Route Between Communication Signal And Non-communication Signal Worksite 506. The module MWSBS Route Between Communication Signal and Non-communication Signal Worksite Module 606 enables transfer of data to MWSBS Route Between Communication Signal And Non-communication Signal Worksite 506 from Worker Safety Management System 201 based on one or more stored rules and/or one or more stored predefined one or more events in MWSBS Route Between Communication Signal And Non-communication Signal Worksite 506.

The module MWSBS Monitoring Schedule Module 607 contains computer instructions to create, read, update and delete data related to one or more monitoring requirements for one or more worksites to ensure safety of the one or more workers, by using MWSBS Worksite Monitoring Schedules 507. The module MWSBS Monitoring Schedule Module 607 enables transfer of data to MWSBS Worksite Monitoring Schedules 507 from Worker Safety Management System 201 based on one or more stored rules and/or one or more stored predefined one or more events in MWSBS Worksite Monitoring Schedules 507.

The module Safety Monitoring Data Module 608 contains computer instructions to create, read, update and delete data related to related monitoring for the purpose of ensuring safety of one or more workers at the one or more worksites by using Safety Monitoring Data 508. The module Safety Monitoring Data Module 608 also generated monitoring data when one or more wearable devices used at the one or more worksites do not satisfy one or more monitoring requirements.

The module Analyzed Safety Data Module 609 contains computer instructions to create, read, update and delete data related to insights and analysis results for the data stored by using Analyzed Safety Data 509. The module Analyzed Safety Data Module 609 may also manage one or more life cycles of the stored one or more insights and/or, one or more analysis results by using stored rules in data model Analyzed Safety Data 509.

The module Robot Control Module 610 contains computer instructions to create, read, update and delete data related to one or more controls and/or one or more configurations of one or more robots that change one or more positions to enable one or more wireless communication links by using Robot Control Data 510. The module Robot Control Module 610 may also manage one or more data life cycles for Robot Control Data 510 by using stored rules in Robot Control Data 510.

The module Robot Communication Module 611 contains computer instructions to create, read, update and delete data related to communication with one or more robots by using Robot Communication Data 511. The module Robot Communication Module 611 may also manage one or more data life cycles for Robot Communication Data 511 by using stored rules in Robot Communication Data 511.

The module Worker Wearable Devices Communication Module 612 contains computer instructions to create, read, update and delete data related to communication with wearable devices worn by the one or more workers at the one or more worksites by using Worker Wearable Devices Communication Data 512. The module Worker Wearable Devices Communication Module 612 may also manage one or more data life cycles for Worker Wearable Devices Communication Data 512 by using stored rules in Worker Wearable Devices Communication Data 512.

The module Worker Safety Management System Communication Module 613 contains computer instructions to create, read, update and delete data related to communication with Worker Safety Management System 201 by using Worker Safety Management System Communication Data 513. The module Worker Safety Management System Communication Module 613 may also manage one or more data life cycles for Worker Safety Management System Communication Data 513 by using stored rules in Worker Safety Management System Communication Data 513.

The module Emergency Communication Module 614 contains computer instructions to create, read, update and delete data related to communication with external and/or internal emergency services and/or help dispatch units services by using Emergency Communication Data 514. The module Emergency Communication Module 614 may also manage one or more data life cycles for Emergency Communication Data 514 by using stored rules in Emergency Communication Data 514. The module Emergency Communication Module 614 may provide an interface to communicate with one or more workers. The module Emergency Communication Module 614 may also include computer instructions to capture human or machine generated voices and/or alarm sounds such as beeps and analyze it to determine requests for help using phrases used and/or alarm sounds to determine occurrence of one or more safety issues. The human voices may be in response to voice generated to query about need for help.

The module GPS Signal, Communication and Power Monitoring Module 615 contains computer instructions to create, read, update and delete data related to detect one or more GPS signals, one or more wireless communication signals and one or more levels of power.

The module Interface Module 616 contains computer instructions to create, read, update and delete data related to external and internal interfaces.

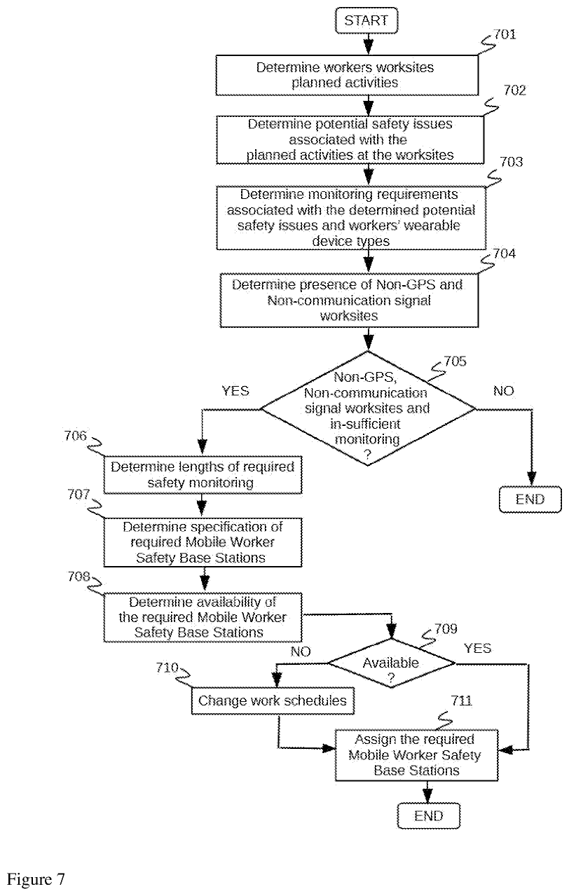

FIG. 7 is a flow chart illustrating an exemplary operation by the one or more Worker Safety Management Systems 201 according to the present invention. The one or more planned activities at the workers' one or more worksites are determined (act 701). One or more potential safety issues associated with the one or more planned activities at the one or more worksites are determined (act 702). One or more monitoring requirements associated with the determined one or more potential safety issues are determined (act 703). Further, one or more workers' one or more wearable device types needed for one or more monitoring are determined (act 703). Presence of one or more Non-GPS signal worksites and/or one or more non-communication signal worksites are determined (act 704). In case, one or more worksites are without GPS signals and/or, without wireless communication signals available and/or, one or more wearable devices do not monitor all of the potential safety issues which may pose threat to safety of the one or more workers (act 705), the one or more time lengths of required one or more safety monitoring are determined (act 706). One or more specifications of required one or more Mobile Worker Safety Base Stations 202 are determined (act 707). The required one or more specifications may include one or more power storage capacities to ensure that the required one or more Mobile Worker Safety Base Station 202 can continue operating during the required one or more time lengths of one or more monitoring, specific safety monitoring such as detection of specific type of gas which cannot be detected by the wearable devices, ability to communicate with the one or more wearable devices and ability to communicate with one or more external and/or internal emergency services and/or one or more help dispatch units services. The availability of one or more Mobile Worker Safety Base Stations with required one or more specifications are determined at the time of the one or more planned activities (act 708). In case, one or more Mobile Worker Safety Base Stations 202 with required specification are available, the one or more Mobile Worker Safety Base Stations 202 are assigned (act 709) (act 711). In case, one or more Mobile Worker Safety Base Stations 202 with required specification are not available, the one or more Mobile Worker Safety Base Stations 202 are assigned after changing the one or more planned activities with or without going through one or more approval workflows (act 709) (act 710) (act 711).

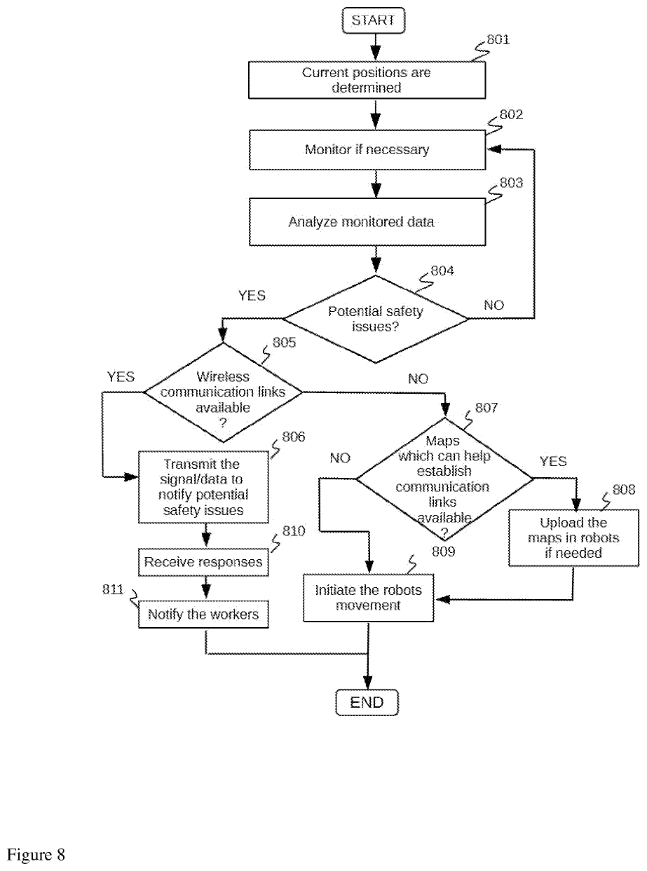

FIG. 8 is a flow chart illustrating an exemplary operation by one or more Mobile Worker Safety Base Stations 202 according to the present invention. The current one or more positions of the one or more Mobile Worker Safety Base Stations 202 are determined by one or more position related data. The one or more data may include one or more positions according to last received GPS signals, one or more positions according to existing GPS signals, one or more time and/or date data at which one or more Mobile Worker Safety Base Stations 202 were expected to be present and/or by the one or more worker inputs with or without using one or more maps stored by the one or more Mobile Worker Safety Base Stations 202 (act 801). The one or more surrounding environments of the one or more Mobile Worker Safety Base Stations 202 are monitored, if necessary (act 802). The monitoring by the one or more Mobile Worker Safety Base Stations 202 may be necessary in specific cases such as: when the one or more wearable devices used by the one or more workers do not provide one or more required monitoring and/or, the one or more wearable devices used by the one or more workers have developed one or more faults and/or, the one or more wearable devices have run out of battery charge. The monitoring by the one or more Mobile Worker Safety Base Stations 202 include analyzing sounds, animal sounds and human voices. The monitored data is analyzed by the Mobile Worker Safety Base Station 202 (act 803). In case, one or more safety issues are determined (act 804), the presence of one or more wireless communication links are determined by the one or more Mobile Worker Safety Base Stations 202 (act 805). The one or more signals and/or, one or more data related to one or more safety issues are generated and transmitted by the one or more Mobile Worker Safety Base Station 202 through the determined one or more wireless communication links. One or more responses are received by Mobile Worker Safety Base Station 202 (act 810) through the available one or more wireless communication links in response to transmitted one or more signals and/or one or more data related to one or more safety issues (act 810). The one or more Mobile Worker Safety Base Stations 202 notify the one or more workers through one or more available means such as computer generated one or more voices, one or more computer generated sounds and flashing light based on the one or more received responses (act 811). In case, one or more safety issues are determined (act 804), and the presence of one or more reliable wireless communication links are not confirmed by the one or more Mobile Worker Safety Base Stations 202 (act 805), presence of relevant one or more maps which can enable one or more wireless communications are determined by the one or more Mobile Worker Safety Base Stations 202 (act 807). The determined one or more maps are loaded into one or more robots if needed (act 808) through one or more wireless and/or wired communication links. The one or more robots have one or more onboard computers and have ability to physically move based on the loaded one or more maps by sensing and/or, determining one or more positions and/or, one or more movements generated be one or more motors and/or GPS signals. The one or more robots also have ability to implement wireless communication with one or more Mobile Worker Safety Base Stations 202 and, with one or more external emergency services and/or, with one or more internal emergency services and/or, with one or more help dispatch unit services. The one or more movements of one or more robots for establishing one or more wireless communication links, are initiated by the one or more Mobile Worker Safety Base Stations 202 (act 809). The one or more signals and/or one or more data indicating one or more occurrences of the one or more safety issues are transferred to the one or more robots (act 809).

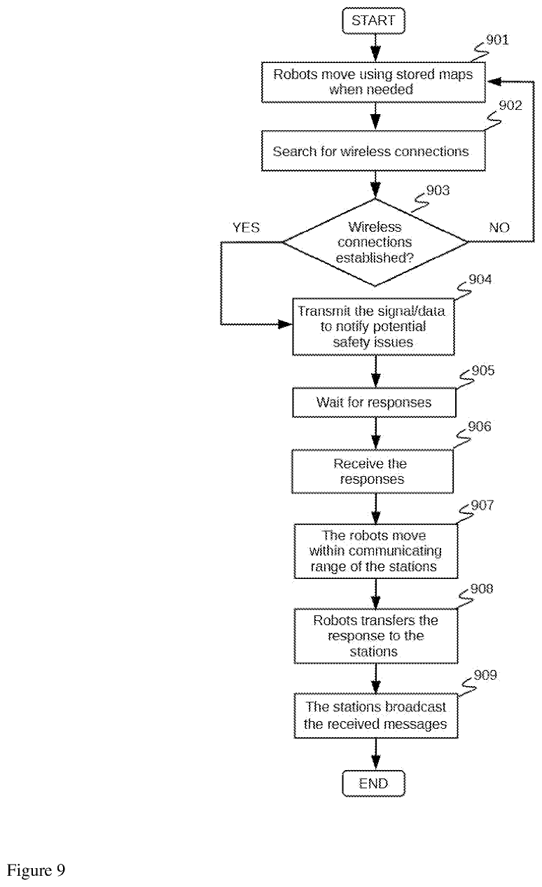

FIG. 9 is a flow chart illustrating an exemplary operation of one or more robots and one or more Mobile Worker Safety Base Stations 202 according to the present invention. The one or more robots moves to one or more new positions with or without using stored one or more maps when need to establish one or more wireless communication links (act 901). The one or more robots search for one or more reliable wireless communication links at the new one or more positions (act 902). The one or more robots continue changing one or more positions until one or more reliable wireless communication links are established (act 903). When the one or more reliable communication links are established, the one or more robots generate and transmit one or more signals and/or, one or more data to notify one or more safety issues (act 904). The the one or more robots wait for one or more responses (act 905). The one or more robot receive the one or more responses (act 906) and move within one or more communicating ranges of the one or more Mobile Worker Safety Base Stations 202 (act 907). The one or more robots transfer the one or more responses to the one or more Mobile Worker Safety Base Stations 202 (act 908). The one or more robots may also notify the one or more workers facing safety issues by one or means as convert the one or more responses into one or more voices and/or, display the one or more responses and/or generating one or more lights (act 908). The one or more Mobile Worker Safety Base Stations 202 notify the one or more workers through one or more available means such as computer generated one or more voices, computer generated one or more sounds and one or more flashing lights (act 909). In another exemplary embodiment, the one or more robots may generate effects such as one or more sounds and/or generate one or more lights to draw attention of one or more monitoring devices and/or human beings in one or surrounding environments when the one or more robots fail to establish one or more wireless communication links after moving away from the one or more Mobile Worker Safety Base Stations 202. In another exemplary embodiment, the one or more robots may physically and/or through remote control activate one or more emergency/hazard/help buttons attached to one or more physical structures to draw attention of one or more monitoring devices and/or human beings in one or more surrounding environments when the one or more robots fail to establish one or more wireless communication links after moving away from the one or more Mobile Worker Safety Base Stations 202.

It is a well known art that acts/steps in flow chart can be split, merged and reordered. Such variations to flows in FIG. 7, FIG. 8 and FIG. 9 are within scope of the invention.

The robots 203 204 in this specification comprises of:
One or more processors coupled to one or more memories
One or more means to physically change one or more positions.
One or more means to communicate through one or more communication channels.
One or more GPS functionality and ability to detect existing positions.
One or more means to change physical position based on stored one or more maps.
One or more means to change physical position based on data from one or more sensor. The robots 203 204 may further comprise of:
One or more means to generate one or more sounds to draw attention.
One or more means to detect one or more emergency buttons and/or one or more hazard buttons and/or one or more help buttons.
One or more means to operate one or more emergency buttons and/or one or more hazard buttons and/or one or more help buttons physically and/or remotely.
One or more means to generate one or more lights to draw attention.
One or more means to implement wireless communication with one or more Mobile Worker Safety Base Stations 202.
One or more means to communicate with one or more workers.
One or more means to communication with one or more external emergency services and/or one or more internal emergency services and/or, one or more help dispatch unit services.

It is to be understood that while the detailed description describes the present invention, the foregoing description is for illustrative purpose and does not limit the scope of the present invention which is defined by the scope of the appended claims. Other embodiments, arrangements and equivalents will be evident to those skilled in the art. Such other embodiments, arrangements and equivalents are within the scope of the present invention as defined by the appended claims. Further, the term “without wireless communication signals” in the claims also include “wireless communication signals which are not reliable enough for effective wireless communications” as described in the specification.

1. A system landscape to ensure safety of one or more workers, the system landscape comprising:
one or more mobile worker safety base stations each of which comprising one or more processors coupled with one or more memories;
one or more robots each of which comprising one or more processors coupled with one or more memories;
one or more wearable devices attached directly or indirectly to the one or more workers and each of which comprising one or more processors coupled with one or more memories;
data related to one or more worksites maps identifying one or more worksites with wireless communication signals and one or more worksites without wireless communication signals, stored by the one or more mobile worker safety base stations;
data related to one or more routes among the one or more worksites with wireless communication signals and the one or more worksites without wireless communication signals for the one or more robots, stored by the one or more mobile worker safety base stations;
data related to one or more worksite maps identifying worksites with GPS signals and worksites without GPS signals, stored by the one or more mobile worker safety base stations;
data related to one or more routes among the worksites with GPS signals and the worksite without GPS signals for the one or more robots, stored by the one or more mobile worker safety base stations;
data related to one or more monitoring schedules for one or more worksites to ensure safety of the one or more workers, stored by the one or more mobile worker safety base stations;
data related to monitoring for the purpose of ensuring safety of the one or more workers at the one or more worksites, stored by the one or more mobile worker safety base stations;
data related to one or more robots control and related one or more configurations, stored by the one or more mobile worker safety base stations;
data related to communication with the one or more robots, stored by the one or more mobile worker safety base stations;
data related to communication with the one or more wearable devices directly or indirectly attached to the one or more workers at the one or more worksites, stored by the one or more mobile worker safety base stations;
one or more computer instructions configured to detect one or more safety issues by the one or more mobile worker safety base stations by using one or more data received from the one or more wearable devices;
one or more computer instructions configured to transfer to the one or more robots, one or more signals and/or one or more data indicating one or more occurrences of the one or more safety issues, by the one or more mobile worker safety base stations;
one or more computer instructions configured to initiate by the one or more mobile worker safety base stations, movement of the one or more robots when presence of one or more wireless communication links are not determined at current determined physical location of the one or more mobile worker safety base stations, to new one or more physical locations where one or more wireless communications links are available;
one or more computer instructions configured to generate and transmit by the one or more robots, one or more signals and/or, one or more data to notify one or more safety issues.

2. The system landscape of claim 1, wherein the one or more mobile worker safety base stations further comprising:
one or more computer instructions configured to determine the current physical location using at least one of:
one or more positions according to last received GPS signals;
one or more positions according to existing GPS signals;
one or more time and/or date data at which the one or more mobile worker safety base stations were expected to be present;
one or more inputs by the one or more workers with or without using the one or more maps stored by the one or more mobile worker safety base stations.

3. The system landscape of claim 1, wherein the one or more robots are configured to:
receive one or more responses;
move within one or more communicating ranges of the one or more mobile worker safety base stations;
transfer the received one or more responses to the one or more mobile worker safety base stations;
notify the one or more workers.

4. The system landscape of claim 3, wherein the one or more mobile worker safety base stations are configured to:
notify the one or more workers by converting the received one or more responses into one or more voices;
notify the one or more workers by converting the received one or more responses into one or more sounds;
notify the one or more workers by generating one or more lights.

5. The system landscape of claim 1, wherein the one or more robots are configured to generate effects to draw attention of one or more monitoring devices and/or one or more human beings in one or more surrounding environments when the one or more robots fail to establish one or more wireless communication links after moving away from the one or more mobile worker safety base stations.

6. The system landscape of claim 1, wherein the one or more robots are configured to load one or more maps required to enable the one or more wireless communication links.

7. The system landscape of claim 1, wherein the one or more robots are configured to establish wireless communication links with at least one of:
one or more external emergency services;
one or more internal emergency services;
one or more help dispatch unit services.

8. The system landscape of claim 1, wherein the one or more robots are configured to physically and/or through remote control activate one or more buttons attached to one or more physical structures to draw attention of one or more monitoring devices and/or human beings in one or more surrounding environments when the one or more robots fail to establish one or more wireless communication links after moving away from the one or more mobile worker safety base stations.

9. The system landscape of claim 1, further comprising at least one of:
stored one or more rules and/or one or more predefined events associated with the stored data related to one or more worksites maps identifying one or more worksites with and without wireless communication signals;
stored one or more rules and/or one or more predefined events associated with the stored data related to one or more routes between the one or more worksites with wireless communication signals and the one or more worksites without wireless communication signals for the one or more robots;
stored one or more rules and/or one or more predefined events associated with the stored data related to one or more worksite maps identifying worksites with GPS signals and worksites without GPS signals within one or more worksites;
stored one or more rules and/or one or more predefined events associated with the stored data related to one or more routes between the worksites with GPS signals and the worksite without GPS signals for the one or more robots;
stored one or more rules and/or one or more predefined events associated with the stored data related to one or more monitoring schedules for one or more worksites to ensure safety of the one or more workers;
stored one or more rules and/or one or more predefined events associated with the stored data related to monitoring for the purpose of ensuring safety of one or more workers at the one or more worksites;
stored one or more rules and/or one or more predefined events associated with the stored data related to the one or more robots control and/or one or more configurations;
stored one or more rules and/or one or more predefined events associated with the stored data related to communication with the one or more robots;
stored one or more rules and/or one or more predefined events associated with the stored data related to communication with one or more wearable devices directly or indirectly attached to the one or more workers at the one or more worksites.

10. The system landscape of claim 1, wherein the one or more mobile worker safety base stations further comprising:
stored data related to insights and analysis results for the data related to monitoring for the purpose of ensuring safety of the one or more workers at the one or more worksites;
one or more computer instructions configured to manage one or more life cycles of the stored one or more insights and one or more analysis results.

11. A system landscape comprising:
one or more mobile worker safety base stations each of which comprising one or more processors coupled with one or more memories and one or more sensors;
one or more wearable devices directly or indirectly attached with one or more workers and each of which comprising one or more processors coupled with one or more memories and one or more sensors;
wherein the one or more mobile worker safety base stations are configured to provide monitoring instead of the one or more wearable devices in one or more of the following cases:
the one or more wearable devices do not provide one or more required monitoring;
the one or more wearable devices used by the one or more workers have developed one or more faults;
the one or more wearable devices have run out of battery charge.

12. The system landscape of claim 11, the act of monitoring include at least one of the following:
determining one or more concentrations of one or more gases in one or more ranges, in one or more surrounding environments;
detecting one or more lights in one or more specific wavelength ranges;
determining one or more intensity of sounds in one or more specific ranges and over one or more specific time lengths;
detecting one or more vibrations in one or more specific intensity ranges;
determining one or more concentrations of one or more solid particles in one or more surrounding environments;
determining one or more strengths of magnetic fields in one or more surrounding environments;
determining one or more falls by determining the one or more device angles within specific range for one or more time periods within one or more specific ranges;
determining one or more heat intensities in one or more surrounding environments;
determining one or more unconscious states by determining the device not changing tilt angle within one or more specific ranges for one or more time periods within one or more specific ranges;
analyzing human sounds and/or animal sounds based on predefined configuration to determine need for help.

13. A worker safety management system to ensure safety of one or more workers, the system comprising:
one or more processors coupled with one or more memories;
stored data related to one or more worksite maps identifying worksites with GPS signals and worksites without GPS signals;
stored data related to one or more worksite maps identifying worksites with and without wireless communication signals;
stored data related to one or more worksite maps identifying one or more worksites with one or more functional electric power sockets;
stored data related to one or more routes between the worksites with GPS signals and the worksites without GPS signals for one or more robots;
stored data related to one or more routes between the one or more worksites with wireless communication signals and the one or more worksites without wireless communication signals;
stored data related to one or more monitoring requirements based on one or more potential safety issues associated with one or more worksites to ensure safety of the one or more workers;
stored data related to the one or more mobile worker safety base stations;
stored data related to one or more assignments of the one or more mobile worker safety base stations to specific worksites according to one or more predetermined work schedules for one or more planned activities;
stored data related to wearable devices that monitors the safety of the one or more workers at one or more worksites based on the one or more potential safety issues associated the one or more planned activities and, generate and send one or more notifications when the safety of the one or more workers is endangered or expected to be endangered;
stored data related to one or more workers' one or more planned activities and associated one or more potential safety issues at the one or more worksites;
stored data related to interface the worker safety management system with one or more external interfaces and/or one or more internal interfaces;
one or more computer instructions configured to determine planned activities at one or more worksites for the one or more workers.

14. The system of claim 13, further comprising at least one of:
one or more computer instructions to maintain the stored data related to one or more worksite maps identifying worksites with GPS signals and worksites without GPS signals according to one or more predefined schedules and/or in response to one or more predefined events by optionally using one or more stored rules;
one or more computer instructions to maintain the stored data related to one or more worksite maps identifying worksites with and without wireless communication signals according to one or more predefined schedules and/or in response to one or more predefined events by optionally using one or more stored rules;
one or more computer instructions to maintain the stored data related to one or more worksite maps identifying one or more worksites with one or more functional electric power sockets according to one or more predefined schedules and/or in response to one or more predefined events by optionally using one or more stored rules;
one or more computer instructions to maintain the stored data related to one or more routes between the worksites with GPS signals and the worksites without GPS signals for the one or more robots according to one or more predefined schedules and/or in response to one or more predefined events by optionally using one or more stored rules;
one or more computer instructions to maintain the stored data related to one or more routes between the one or more worksites with wireless communication signals and the one or more worksites without wireless communication signals according to one or more predefined schedules and/or in response to one or more predefined events by optionally using one or more stored rules;
one or more computer instructions to maintain the stored data related to one or more monitoring requirements based on one or more potential safety issues associated with one or more worksites to ensure safety of the one or more workers according to one or more predefined schedules and/or in response to one or more predefined events by optionally using one or more stored rules;
one or more computer instructions to maintain the stored data related to the one or more mobile worker safety base stations according to one or more predefined schedules and/or in response to one or more predefined events by optionally using one or more stored rules;
one or more computer instructions to maintain the stored data related to one or more assignments of the one or more mobile worker safety base stations to specific worksites according to one or more predetermined work schedules for one or more planned activities according to one or more predefined schedules and/or in response to one or more predefined events by optionally using one or more stored rules;
one or more computer instructions to maintain the stored data related to wearable devices that monitors the safety of the one or more workers at one or more worksites based on the one or more potential safety issues associated the one or more planned activities and, generate and send one or more notifications when the safety of the one or more workers is endangered or expected to be endangered according to one or more predefined schedules and/or in response to one or more predefined events by optionally using one or more stored rules;
one or more computer instructions to maintain the stored data related to the one or more workers' one or more planned activities and associated one or more potential safety issues at the one or more worksites according to one or more predefined schedules and/or in response to one or more predefined events by optionally using one or more stored rules;
one or more computer instructions to maintain the stored data related to interface the worker safety management system with one or more external interfaces and/or one or more internal interfaces according to one or more predefined schedules and/or in response to one or more predefined events by optionally using one or more stored rules.

15. The system of claim 13, further comprising at least one of:
stored one or more rules based on one or more self-learning algorithms associated with stored data related to one or more worksite maps identifying worksites with GPS signals and worksites without GPS signals;
stored one or more rules based on one or more self-learning algorithms associated with stored data related to one or more worksite maps identifying worksites with and without wireless communication signals;
stored one or more rules based on one or more self-learning algorithms associated with stored data related to one or more worksite maps identifying one or more worksites with one or more functional electric power sockets;
stored one or more rules based on one or more self-learning algorithms associated with stored data related to one or more routes between the worksite with GPS signals and the worksite without GPS signals for the one or more robots;
stored one or more rules based on one or more self-learning algorithms associated with stored data related to one or more routes between the one or more worksites with wireless communication signals and the one or more worksites without wireless communication signals;
stored one or more rules based on one or more self-learning algorithms associated with stored data related to one or more monitoring requirements based on one or more potential safety issues associated with one or more worksites to ensure safety of the one or more workers;
stored one or more rules based on one or more self-learning algorithms associated with stored data related to the one or more mobile worker safety base stations;
stored one or more rules based on one or more self-learning algorithms associated with stored data related to one or more assignments of the one or more mobile worker safety base station to specific worksites according to one or more predetermined work schedules for one or more planned activities;
stored one or more rules based on one or more self-learning algorithms associated with stored data related to wearable devices that monitors the safety of the one or more workers at one or more worksites based on the one or more potential safety issues associated the one or more planned activities and, generate and send one or more notifications when the safety of the one or more workers is endangered or expected to be endangered;
stored one or more rules based on one or more self-learning algorithms associated with stored data related to the one or more workers' one or more planned activities and associated one or more potential safety issues at the one or more worksites;
stored one or more rules based on one or more self-learning algorithms associated with stored data related to interface the worker safety management system with one or more external interfaces and/or one or more internal interfaces;
one or more computer instructions configured to determine one or more planned activities at one or more worksites for the one or more workers.

16. The system of claim 13, further comprising one or more computer instructions configured to:
determine one or more potential safety issues associated with the one or more planned activities at the one or more worksites;
determine one or more monitoring requirements associated with the determined one or more potential safety issues;
determine one or more wearable device types needed for one or more monitoring for the one or more workers;
determine presence of one or more worksites without GPS signals and/or one or more worksites without wireless communication signals;
determine one or more time lengths of required one or more safety monitoring at least one of the following case:
(a) one or more worksites are without GPS signals,
(b) wireless communication signals available,
(c) one or more wearable devices do not monitor all of the determined potential safety issues which may pose threat to safety of the one or more workers;
determine required specification of the one or more mobile worker safety base stations;
assign the one or more mobile worker safety base stations with the required specifications for the determined one or more planned activities.

17. The system of claim 16, further comprising one or more computer instructions configured to change the one or more planned activities with or without going through one or more approval workflows in case, the one or more mobile worker safety base stations with the required specifications are not available.

18. The system of claim 16, further comprising one or more computer instructions configured to assign the one or more mobile worker safety base stations based on power required to continue monitoring throughout the one or more required time lengths of safety monitoring.

19. The system of claim 16, further comprising one or more computer instructions configured to provide at least one of following stored data to the one or more mobile worker safety base stations:
stored data related to one or more worksite maps identifying worksites with GPS signals and worksites without GPS signals;
stored data related to one or more worksite maps identifying worksites with and without wireless communication signals;
stored data related to one or more worksite maps identifying one or more worksites with one or more functional electric power sockets;
stored data related to one or more routes between the worksites with GPS signals and the worksites without GPS signals for the one or more robots;
stored data related to one or more routes between the one or more worksites with wireless communication signals and the one or more worksites without wireless communication signals;
stored data related to one or more monitoring requirements based on one or more potential safety issues associated with the one or more worksites to ensure safety of the one or more workers.
